(19) United States
(12) Patent Application Publication
(10) Pub. No.: US 2011/0070486 A1
(43) Pub. Date: Mar. 24, 2011

(54) IONIC LIQUID

(75) Inventors: Hajime Matsumoto, Osaka (JP); Naohiro Terasawa, Osaka (JP); Hikari Sakaebe, Osaka (JP); Seiji Tsuzuki, Ibaraki (JP)

(73) Assignee: NATIONAL INSTITUTE OF ADVANCED INDUSTRIAL SCIENCE AND TECHNOLOGY, Tokyo (JP)

(21) Appl. No.: 12/991,817

(22) PCT Filed: May 1, 2009
(86) PCT No.: PCT/JP2009/058579

§ 371 Date: Nov. 9, 2010

(30) Foreign Application Priority Data
Sep. 10, 2008 (JP) 2008-231764

(51) Int. Cl. H01M 10/0564; H01G 9/035

(52) U.S. Cl. 429/201; 252/62.2

(57) ABSTRACT

An object of the invention is to provide an ionic liquid having a low viscosity and low melting point, and having a high electrical conductivity and thermal stability. The ionic liquid comprises fluorosulfonyl(trifluoromethylsulfonylamide) (FTA) as an anion and a cation selected from N1111, N1112, N1113, N1122, N1133, N2221, N1224, DEME, N2222, N3333, N4444, N5555, AS44, DMI, PMI, BMI, Py11, Py12, Py14, PP11, PP12, PP13, PP14, P2222, and PS44.

### TECHNICAL FIELD

The present invention relates to ionic liquids, and more particularly to ionic liquids having low viscosities and low melting points, and having high electrical conductivities.

### BACKGROUND ART

Ionic liquids have attracted special attention for the past several years because of their potential uses as electrolytes for a variety of electrochemical devices, such as lithium secondary batteries, dye-sensitized solar cells, actuators, and electric double-layer capacitors; reaction media; and catalysts for organic syntheses. Compared with known organic liquid electrolytes, ionic liquids as electrolytes have the main advantages of non-flammability, non-volatility and high thermal stability. With regard to most of the ionic liquids so far reported, tetrafluoroborate (BF₄⁻) and bistrifluoromethylsulfonylamide([(CF₃SO₂)₂N]⁻, abbr. [TFSA]⁻, is the same as the ionic liquid previously named “bistrifluoromethylsulfonylimide”, abbr. TFSI; however, it is classified as an amide in this specification, as recently recommended by IUPAC.) have attracted attention as anions for ionic liquids because of their high electrochemical stabilities and thermal stabilities (Patent Literatures 1 and 2). [TFSA]⁻ salts, in particular, can easily form ionic liquids even with cations such as aliphatic quaternary ammonium that do not easily form ionic liquids because of their low charge dispersibility; and also have a high electrochemical stability compared with conventional imidazolium salts (Patent Literature 3). For these reasons, [TFSA]⁻ salts have enabled electrodeposition of lithium; however, they have not realized charging/discharging at a significantly increased charge/discharge current density when used in, for example, Li/LiCoO₂ cells. Bisfluoromethylsulfonylamide([(FSO₂)₂N]⁻; [FSA]⁻), which is also an amide anion, has recently been reported to exhibit excellent basic physical properties and battery characteristics. However, because lithium salts (Non-Patent Literature 1) and ionic liquids (Non-Patent Literature 2) of Bisfluoromethylsulfonylamide have a low thermal stability, there is a need for ionic liquids that have higher thermal decomposition temperatures and provide improved battery characteristics.

Patent Literature 4 discloses salts containing fluorosulfonyl(trifluoromethylsulfonylamide) (FTA). However, Patent Literature 4 fails to disclose the melting points of the salts obtained in its Examples; therefore, the fact that these salts are ionic liquids is not established.

### CITATION LIST

### Patent Literature

PTL 1: Japanese Unexamined Patent Publication No. 2002-099001
PTL 2: Japanese Unexamined Patent Publication No. 2003-331918
PTL 3: Japanese Patent No. 2981545 PTL 4: Japanese Unexamined Patent Publication No. 2005-200359

### Non-Patent Literature

NPL 1: K. Kubota, T. Nohira, T. Goto, R. Hagiwara, Electrochem. Commun., 10 (2008), pp. 1886-1888.
NPL 2: W. Yadong, K. Zaghib, A. Guerfi, F. F. C. Bazito, R. M. Torresi, J. R. Dahn, Electrochim. Acta, 52 (2007), p. 6346.

### SUMMARY OF INVENTION

### Technical Problem

An object of the present invention is to provide ionic liquids having low viscosities and low melting points, and having high electrical conductivities and high thermal stabilities.

### Solution to Problem

As a result of extensive research in view of the foregoing problems, the present inventors found that an ionic liquid comprising fluorosulfonyl(trifluoromethylsulfonylamide) (FTA) as an anion and a specific cation exhibits a low viscosity, a low melting point, a high electrical conductivity at low temperatures, and a relatively high thermal stability.

In summary, the present invention provides the following ionic liquids.

Item 1. An ionic liquid comprising fluorosulfonyl(trifluoromethylsulfonylamide) (FTA) as an anion and a cation selected from the following cations:
tetramethylammonium (N1111);
ethyltrimethylammonium (N1112);
n-propyltrimethylammonium (N1113);
diethyldimethylammonium (N1122);
di-n-propyldimethylammonium (N1133);
triethylmethylammonium (N2221);
n-butyldiethylmethylammonium (N1224);
N,N-diethyl-N-methyl-N-(2-methoxyethyl)ammonium (DEME);
tetraethylammonium (N2222);
tetra-n-propylammonium (N3333);
tetra-n-butylammonium (N4444);
tetra-n-pentylammonium (N5555);
5-azoniaspiro[4.4]nonane (AS44);
dimethylimidazole (DMI);
propylmethylimidazole (PMI);
butylmethylimidazole (BMI);
N,N-dimethylpyrrolidinium (Py11);
N-methyl-N-ethylpyrrolidinium (Py12);
N-methyl-N-butylpyrrolidinium (Py14);
N,N-dimethyl-piperidinium (PP11);
N-methyl-N-ethyl-piperidinium (PP12);
N-methyl-N-propyl-piperidinium (PP13);
N-methyl-N-butyl-piperidinium (PP14);
tetraethylphosphonium (P2222); and
5-phosphoniaspiro[4,4]nonane (PS44).
   Item 2. The ionic liquid according to Item 1, wherein the cation is tetraethylammonium (N2222) or triethylmethylammonium (N2221).
   Item 3. The ionic liquid according to Item 1, wherein the cation is tetramethylammonium (N1111), ethyltrimethylammonium (N1112), or n-propyltrimethylammonium (N1113).
   Item 4. The ionic liquid according to Item 1, wherein the cation is N,N-diethyl-N-methyl-N-(2-methoxyethyl)ammonium (DEME).
   Item 5. The ionic liquid according to Item 1, wherein the cation is tetraethylphosphonium (P2222).
   Item 6. The ionic liquid according to Item 1, wherein the cation is N-methyl-N-propyl-piperidinium (PP13).
   Item 7. The ionic liquid according to Item 1, wherein the cation is 5-azoniaspiro[4.4]nonane (AS44).

### ADVANTAGEOUS EFFECTS OF INVENTION

The ionic liquids of the present invention are suitable for use in electrochemical devices, such as lithium secondary batteries, fuel cells, dye-sensitized solar cells, and electric double-layer capacitors; as solvents for chemical reactions; and as lubricants.

### DESCRIPTION OF EMBODIMENTS

The structures of cations used in the invention are schematically shown below:

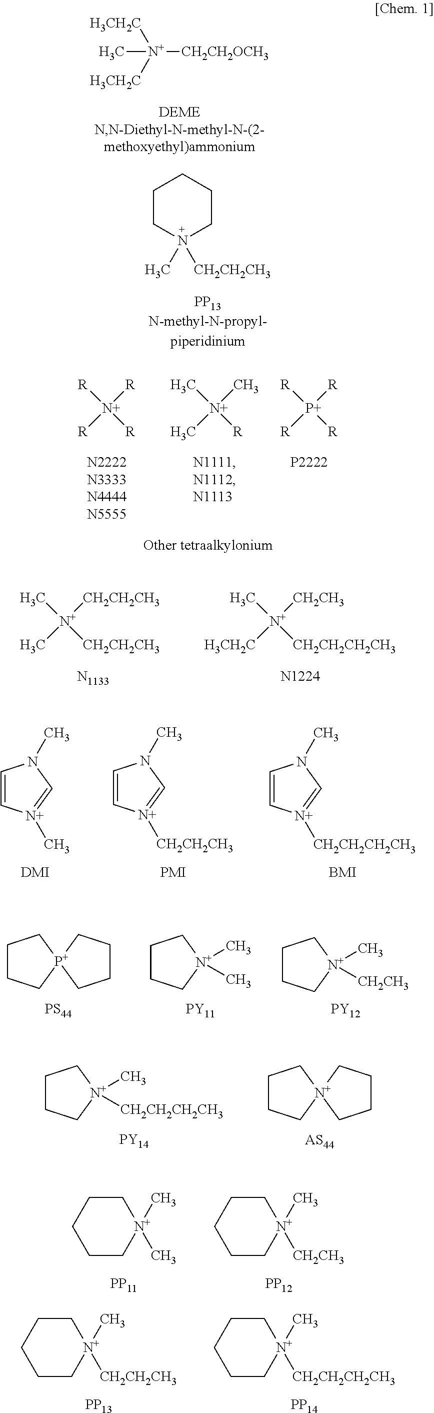

The structure of the anion used in the invention and the structures of anions for comparison are shown below:

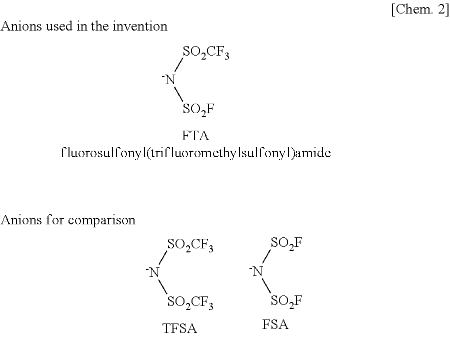

The ionic liquids provided by the invention have melting points of 120° C. or less, preferably 80° C. or less, more preferably 50° C. or less, still more preferably 25° C. or less, even more preferably 0° C. or less, and most preferably −20° C. or less. For example, for use in fuel cells, a wide range of ionic liquids having melting points of 80° C. or less can be used. For use in energy device such as solar cells, lithium cells, and capacitors, and electrochemical devices such as electrochromic devices and electrochemical sensors, ionic liquids having melting points of preferably not more than room temperature (25° C.), and more preferably 0° C. or less, can be used.

Even if the melting points of ionic liquids used in the invention are not clearly observable, ionic liquids having glass transition temperatures of −70° C. or less, preferably −80° C. or less, more preferably −90° C. or less, and still more preferably −100° C. or less, can be considered equal to ionic liquids having melting points of the same temperatures.

In the invention, fluorosulfonyl(trifluoromethylsulfonylamide) (FTA; [(FSO₂)(CF₃SO₂)N]⁻) is used as an anion component of ionic liquids. This anion is a known compound, and can be produced according to, for example, Patent Literature 3.

An ionic liquid of the invention can be produced by mixing FTA ([(FSO₂)(CF₃SO₂)N]⁻) and a salt of a cation component such as an alkali metal ion (Na⁺, K⁺, Li⁺, Cs⁺, etc.), an alkaline earth metal ion (Ca²⁺, Mg²⁺, Ba²⁺ etc.), or Bu₃Sn⁺ with a salt containing a specific cation of the invention, followed by separation of the ionic liquid. For example, an ionic liquid containing FTA and a cation of the invention can be preferably obtained by mixing the salt of FTA([FSO₂)(CF₃SO₂)N]⁻)H⁺, which is obtained by passage through an ion exchange resin, with a salt of (any of the cations of the invention)⁺(OH)⁻, followed by removal of the resulting water. When a desired molten salt is extractable, a salt-exchange reaction for obtaining the ionic liquid can be carried out by solvent extraction.

The cation component for an ionic liquid of the invention is selected from the following cations:
tetramethylammonium (N1111);
ethyltrimethylammonium (N1112);
n-propyltrimethylammonium (N1113);
diethyldimethylammonium (N1122);
di-n-propyldimethylammonium (N1133);
triethylmethylammonium (N2221);
n-butyldiethylmethylammonium (N1224);
N,N-diethyl-N-methyl-N-(2-methoxyethyl)ammonium (DEME);
tetraethylammonium (N2222);
tetra-n-propylammonium (N3333);
tetra-n-butylammonium (N4444);
tetra-n-pentylammonium (N5555);
5-azoniaspiro[4.4]nonane (AS44);
dimethylimidazole (DMI);
propylmethylimidazole (PMI);
butylmethylimidazole (BMI);
N,N-dimethylpyrrolidinium (Py11);
N-methyl-N-ethylpyrrolidinium (Py12);
N-methyl-N-butylpyrrolidinium (Py14);
N,N-dimethyl-piperidinium (PP11);
N-methyl-N-ethyl-piperidinium (PP12);
N-methyl-N-propyl-piperidinium (PP13);
N-methyl-N-butyl-piperidinium (PP14);
tetraethylphosphonium (P2222); and
5-phosphoniaspiro[4,4]nonane (PS44).

All of these cations are known, and are available or can be produced according to known methods.

The molecular weight of FTA, which is the anion used in the invention, is between the molecular weights of TFSA ([(CF₃SO₂)₂N]⁻) and FSA ([(FSO₂)₂N]⁻), which are anions having symmetric structures. Therefore, the physical properties of FTA, such as viscosity, electrical conductivity, and diffusion coefficient, are also expected to be intermediate between the physical properties of TFSA and FSA. However, because the FTA anion has an asymmetric structure, FTA is expected to have a dramatically lower melting point. The present inventors found that, particularly when FTA is combined with a specific cation of the invention, the resulting ionic liquid has a melting point that is lower than expected, and has an electrical conductivity closer to that of FSA salts than an intermediate between the conductivities of TFSA and FSA. Furthermore, with respect to thermal stability, which has been a drawback in FSA, the ionic liquid was found to exhibit a thermal stability generally higher than that of FSA.

The present inventors ascertained that the FTA anion used in the invention exhibits a high electrochemical stability comparable to that of known anions. The present inventors are the first to obtain ionic liquids containing N2222, AS44, and PS44, which have high symmetry, and whose salts generally have high melting points. The fact that a liquid was formed using the cation (N2222), from which ionic liquids could not heretofore be produced, indicates that the resulting ionic liquid is an amide salt that exhibits the highest oxidation stability of all the previously known amide salts.

The twenty-five cation components used in the invention (N1111, N1112, N1113, N1122, N1133, N2221, N1224, DEME, N2222, N3333, N4444, N5555, AS44, DMI, PMI, BMI, Py11, Py12, Py14, PP11, PP12, PP13, PP14, P2222, and PS44) may be used alone; however, a combination of two cations or more can further reduce the melting point and viscosity of the ionic liquid.

While FTA is used as an anion for ionic liquids, other anions may be additionally used as long as FTA is used as the main anion component.

### EXAMPLES

The present invention will be described in more detail below with reference to Examples.

### Example 1

### Methods

For compound identification, ¹H NMR (500.2 MHz), ¹⁹F NMR (470.6 MHz), and ¹¹B NMR (160.5 MHz) spectra were measured using a JEOL ECA-500 FT-NMR spectrometer. FAB-MS spectra were measured using a JEOL JMS-HX110/110A spectrometer.

### Density:

The density of an ionic liquid was determined by measuring the weight of 1.0 mL of the ionic liquid at 25° C. three times.

### Specific Conductivity:

The ionic conductivity (K) of a neat (solvent-free) ionic liquid was determined in a sealed conductivity cell by using a conductivity meter (Radiometer Analytical, model CDM230).

### Viscosity:

The viscosity of a 0.6 mL sample at 25° C. was measured using a viscometer (Brookfield model DV-III+).

### Thermogravimetric Analysis (TGA):

TGA was performed using a thermal analysis system (Seiko Instruments, TG/DTA 6200). A sample with an average weight of 5 mg was placed in a platinum pan and heated to about 40 to 600° C. at a rate of 10° C./min under a nitrogen stream. The beginning of decomposition was defined as the decomposition temperature (T_{d}).

### Differential Scanning Calorimetry (DSC):

DSC was performed as follows: A liquid nitrogen cooler was connected to a thermal analysis system (Perkin/Elmer Pyris 1), measurement was conducted at a temperature of −150 to 250° C. in a helium stream at 10° C./min, and the resulting phase transition temperature was determined as the melting point. In the case of a melting point above room temperature, a melting phenomenon was visually observed at around the measurement temperature.

### Synthesis

All of the raw materials used were commercially available, and used in unpurified form. The syntheses of compounds were performed according to the methods described in Reference Documents 1 to 3.

### Synthesis of K[CF₃SO₂NH]

A solution of KO^{t}Bu (36.9 g, 0.33 mol) in anhydrous MeOH (150 ml) was added dropwise to a stirred solution of CF₃SO₂NH₂ (49.3 g, 0.33 mol) in anhydrous MeOH (250 ml). The reaction mixture was stirred at 50° C. for 2 hours. The stirred mixture was evaporated for 24 hours at 0.02 Torr to give a white solid (60.53 g, 96.4%).

¹⁹F NMR (D₂O, CFCl₃, 470.6 MHz) δ −78.0 (s, 3F); MS m/z (%) 149 (100) [CF₃SO₂NH]⁻; Anal. Calcd. for CF₃O₂SNK: C, 6.4; H, 0.5; N, 7.5; Found: C, 6.3; H, 0.7; N, 7.7.

### Synthesis of K[CF₃SO₂NSO₂F]

(FSO₂)₂O¹⁾) (69.5 g, 0.38 mol) was added dropwise to a stirred solution of K[CF₃SO₂NH] (60.0 g, 0.32 mol) in anhydrous Et₂O (980 ml) over a period of 30 minutes at −20° C.

The mixture was stirred for 3 hours at −20° C., and filtered.

The crude product (21.5 g) was washed with MeOH and filtered. After removing the solvent under vacuum, the residue was recrystallized from acetone/CHCl₃ to give a product.

¹⁹F NMR (CD₃OD, CFCl₃, 470.6 MHz) δ 56.8 (s, 1F), −78.0 (s, 3F); MS m/z (%) 230 (100) [CF₃SO₂NSO₂F]⁻; Anal. Calcd. for CF₄O₄S₂NK: C, 4.5; N, 5.2; Found: C, 4.3; N, 5.4.

Equimolar amounts of the thus-obtained potassium salt of FTA and each of various ammonium bromides were mixed, and unwanted FTA ionic liquid in the resulting water was extracted with dichloromethane. After washing the extracted product with water several times, the dichloromethane was distilled off to give an ionic liquid.

### DEME[FTA] (0.65 g, 80.3%)

¹H NMR (CD₃OD, TMS, 500.2 MHz) δ 1.33 (m, 6H), 3.04 (s, 3H), 3.38 (s, 3H), 3.43 (q, J=7.3 Hz, 4H), 3.51 (t, J=4.5 Hz, 2H), 3.78 (m, 2H); ¹⁹F NMR (CD₃OD, CFCl₃, 470.6 MHz) δ 56.6 (s, F), −78.2 (s, 3F); MS m/z (%) 146 (100) [DEME], 230 (100) [FTA]⁻; A nal. Calcd. for C₉H₂₀N₂F₄O₅S₂: C, 28.7; H, 5.4; N, 7.4; F, 20.2; Found: C, 28.8; H, 5.1; N, 7.5; F, 20.2.

### PP13[FTA] (2.30 g, 88.2%)

¹H NMR (CD₃OD, TMS, 500.2 MHz) δ 1.02 (t, J=7.3 Hz, 3H), 1.62-1.76 (m, 2H), 1.77-1.84 (m, 2H), 1.90 (m, 4H), 3.04 (s, 3H), 3.27-3.31 (m, 2H), 3.35 (t, J=5.8 Hz, 4H); ¹⁹F NMR (CD₃OD, CFCl₃, 470.6 MHz) δ 56.9 (s, F), −78.1 (s, 3F); MS m/z (%) 142 (100) [PP13]⁺, 230 (100) [FTA]⁻; Anal. Calcd. for C₁₀H₂₀N₂F₄O₄S₂: C, 32.3; H, 5.4; N, 7.5; F, 20.4; Found: C, 32.4; H, 5.2; N, 7.6; F, 20.4.

### N1111[FTA]

N1111Br (0.54 g, 3.5 mmol) was added to a stirred solution of K[CF₃SO₂NSO₂F] (0.94 g, 3.5 mmol) in CH₃CN (10 ml) at room temperature. The mixture was stirred for another 3 hours. After distilling off the solvent, the white solid was dissolved in CH₂Cl₂, followed by filtration. The solvent was removed under vacuum. The resulting liquid was dried at 80° C. for 24 hours at 0.02 Torr (1.06 g, 99.5%).

¹H NMR (CD₃OD, TMS, 500.2 MHz) δ 3.19 (s, 12H); ¹⁹F NMR (CD₃OD, CFCl₃, 470.6 MHz) δ 56.6 (s, F), −78.2 (s, 3F); MS m/z (%) 74 (100) [N1111]⁺, 230 (100) [FTA]⁻; Anal. Calcd. for C₅H₁₂N₂F₄O₁S₂: C, 19.7; H, 4.0; N, 9.2; F, 25.0; Found: C, 19.9; H, 3.9; N, 9.3; F, 24.8.

### N2221[FTA]

MS m/z (%) 116 (100) [N2221]⁺, 230 (100) [FTA]⁻; Anal. Calcd. for C₈H₁₈N₂F₄O₄S₂: C, 27.7; H, 5.2; N, 8.1; F, 21.9; Found: C, 27.8; H, 5.2; N, 8.2; F, 21.9.

### N1112[FTA] (0.51 g, 22.3%)

¹H NMR (CD₃OD, TMS, 500.2 MHz) δ 1.39 (t, J=7.5 Hz, 3H), 3.10 (s, 9H), 3.41 (q, J=7.2 Hz, 2H); ¹⁹F NMR (CD₃OD, CFCl₃, 470.6 MHz) δ 56.6 (s, F), −78.1 (s, 3F); MS m/z (%) 88 (100) [N1112]⁺, 230 (100) [FTA]; Anal. Calcd. for C₆H₁₄N₂F₄O₄S₂: C, 22.6; H, 4.4; N, 8.8; F, 23.9; Found: C, 22.4; H, 4.4; N, 8.9; F, 24.0.

### N1113[FTA] (1.46 g, 62.9%)

¹H NMR (CD₃OD, TMS, 500.2 MHz) δ 1.02 (t, J=7.3 Hz, 3H), 1.78-1.86 (m, 2H), 3.12 (s, 9H), 3.26-3.32 (m, 2H); ¹⁹F NMR (CD₃OD, CFCl₃, 470.6 MHz) δ 56.8 (s, F), −78.1 (s, 3F); MS m/z (%) 102 (100) [N1113]⁺, 230 (100) [CF₃SO₂NSO₂F]⁻; Anal. Calcd. for C₇H₁₆N₂F₄O₄S₂: C, 25.3; H, 4.9; N, 8.4; F, 22.9; Found: C, 25.5; H, 4.8; N, 8.5; F, 22.7.

### N2222[FTA] (2.13 g, 84.4%)

¹H NMR (CD₃OD, TMS, 500.2 MHz) δ 1.29 (t, J=7.5 Hz, 12H), 3.29 (q, J=7.2 Hz, 8H); ¹⁹F NMR (CD₃OD, CFCl₃, 470.6 MHz) δ 56.7 (s, F), −78.1 (s, 3F); MS m/z (%) 130 (100) [N2222]⁺, 230 (100) [FTA]; Anal. Calcd. for C₉H₂₀N₂F₄O₄S₂: C, 30.0; H, 5.6; N, 7.8; F, 21.1; Found: C, 29.8; H, 5.5; N, 7.8; F, 21.1.

### P2222[FTA] (2.38 g, 90.1%)

¹H NMR (CD₃OD, TMS, 500.2 MHz) δ 1.22-1.28 (m, 12H), 2.21-2.28 (m, 8H); ¹⁹F NMR (CD₃OD, CFCl₃, 470.6 MHz) δ 56.6 (s, F), −78.1 (s, 3F); MS m/z (%) 147 (100) [P2222]⁺, 230 (100) [FTA]⁻; Anal. Calcd. for C₉H₂₀NPF₄O₄S₂: C, 28.7; H, 5.3; N, 3.7; F, 20.1; Found: C, 28.7; H, 5.2; N, 3.7; F, 19.7.

### Comparative Example 1

Compounds corresponding to those obtained in Example 1 were synthesized in the same manner as above, except that TFSA or FSA was used instead of FTA.

### Comparative Example 2

An ionic liquid consisting of a salt of FTA and EMI (1-ethyl-3-methylimidazolium) was prepared in the same manner as above.

### Example 2

The ionic liquids shown below were produced. All of the raw materials used were commercially available, and used in unpurified form. The syntheses of the compounds were performed according to the method described in Reference Document 1-7.

### Py13[FTA] (2.17 g, 86.5%)

¹H NMR (CD₃OD, TMS, 500.2 MHz) δ 1.02 (t, J=7.3 Hz, 3H), 1.80-1.87 (m, 2H), 2.22 (s 4H), 3.05 (s, 3H), 3.28-3.32 (m, 2H), 3.47-3.56 (m, 4H); ¹⁹F NMR (CD₃OD, CFCl₃, 470.6 MHz) δ 56.8 (s, F), −78.1 (s, 3F); MS m/z (%) 128 (100) [Py13]⁺, 230 (100) [CF₃SO₂N SO₂F]⁻; Anal. Calcd. for C₉H₁₈N₂F₄O₄S₂: C, 30.2; H, 5.1; N, 7.8; F, 21.2; Found: C, 30.1; H, 4.9; N, 7.7; F, 21.2.

### DEME[FSA]

MS m/z (%) 146 (100) [DEME]⁺, 180 (100) [FSA]⁻; Anal. Calcd. for C₈H₂₀N₂F₂O₅S₂: C, 29.4; H, 6.2; N, 8.6; F, 11.6; Found: C, 29.4; H, 6.2; N, 8.5; F, 11.6.

### N2221[FSA]

MS m/z (%) 116 (100) [N2221]⁺, 180 (100) [FSA]⁻; Anal. Calcd. for C₇H₁₈N₂F₂O₄S₂: C, 28.4; H, 6.1; N, 9.5; F, 12.8; Found: C, 28.2; H, 6.0; N, 9.4; F, 12.7.

### N1113[FSA]

MS m/z (%) 102 (100) [N1113]⁺, 180 (100) [FSA]⁻; Anal. Calcd. for C₆H₁₆N₂F₂O₄S₂: C, 25.5; H, 5.7; N, 9.9; F, 13.5; Found: C, 25.5; H, 5.6; N, 10.0; F, 13.5.

### N1112[FSA]

MS m/z (%) 88 (100) [N1112]⁺, 180 (100) [FSA]⁻; Anal. Calcd. for C₅H₁₄N₂F₂O₄S₂: C, 22.4; H, 5.3; N, 10.4; F, 14.2; Found: C, 22.3; H, 5.2; N, 10.4; F, 14.0.

### N2222[FSA]

MS m/z (%) 130 (100) [N2222]⁺, 180 (100) [FSA]⁻; Anal. Calcd. for C₈H₂₀N₂F₂O₄S₂: C, 31.0; H, 6.5; N, 9.0; F, 12.2; Found: C, 30.8; H, 6.4; N, 9.0; F, 12.2.

### N1111[FSA]

MS m/z (%) 74 (100) [N1111]⁺, 180 (100) [FSA]⁻; Anal. Calcd. for C₄H₁₂N₂F₂O₄S₂: C, 18.9; H, 4.8; N, 11.0; F, 14.9; Found: C, 18.8; H, 4.7; N, 11.0; F, 14.9.

### P2222[TFSA]

MS m/z (%) 147 (100) [P2222]⁺, 280 (100) [TFSA]⁻; Anal. Calcd. for C₁₀H₂₀NPF₆O₄S₂: C, 28.1; H, 4.7; N, 3.3; F, 26.7; Found: C, 28.0; H, 4.6; N, 3.2; F, 25.6.

### P2222[FSA]

MS m/z (%) 147 (100) [P2222]⁺, 180 (100) [FSA]⁻; Anal. Calcd. for C₈H₂₀NPF₂O₄S₂: C, 29.4; H, 6.2; N, 4.3; F, 11.6; Found: C, 29.2; H, 6.1; N, 4.1; F, 11.4.

### PP14[FTA]

MS m/z (%) 156 (100) [PP14]⁺, 230 (100) [CF₃SO₂NSO₂F]⁻; Anal. Ca lcd. for C₁₁H₂₂N₂F₄O₄S₂: C, 34.2; H, 5.7; N, 7.3; F, 19.7; Found: C, 33.9; H, 5.7; N, 7.1; F, 19.7.

### PP14[FSA]

MS m/z (%) 156 (100) [PP14]⁺, 180 (100) [FSA]⁻; Anal. Calcd. for C₁₀H₂₂N₂F₂O₄S₂: C, 35.7; H, 6.6; N, 8.3; F, 11.3; Found: C, 35.6; H, 6.6; N, 8.3; F, 11.4.

### PP14[TFSA]

MS m/z (%) 156 (100) [PP14]⁺, 280 (100) [TFSA]; Anal. Calcd. for C₁₂H₂₂N₂F₆O₄S₂: C, 33.02; H, 5.08; N, 6.42; F, 26.12; Found: C, 32.7; H, 5.0; N, 6.2; F, 26.3.

### PP11[FTA]

MS m/z (%) 114 (100) [PP11]⁺, 230 (100) [FTA]⁻; Anal. Calcd. for C₈H₁₆N₂F₄O₄S₂: C, 27.9; H, 4.7; N, 8.1; F, 22.1; Found: C, 27.7; H, 4.5; N, 8.2; F, 22.1.

### PP11[FSA]

MS m/z (%) 114 (100) [PP11]⁺, 180 (100) [FSA]; Anal. Calcd. for C₇H₁₆N2F₂O₄S₂: C, 28.6; H, 5.5; N, 9.5; F, 12.9; Found: C, 28.4; H, 5.3; N, 9.6; F, 12.9.

### N5555[FSA]

MS m/z (%) 298 (100) [N5555]⁺, 180 (100) [FSA]⁻; Anal. Calcd. for C₂₀H₄₄N₂F₂O₄S₂: C, 50.2; H, 9.3; N, 5.9; F, 7.9; Found: C, 50.0; H, 9.3; N, 5.8; F, 7.9.

### N4444[FSA]

MS m/z (%) 242 (100) [N4444]⁺, 180 (100) [FSA]⁻; Anal. Calcd. for C₁₆H₃₆N₂F₂O₄S₂: C, 45.5; H, 8.6; N, 6.6; F, 9.0; Found: C, 45.2; H, 8.7; N, 6.6; F, 9.1.

### N3333[FSA]

MS m/z (%) 186 (100) [N3333]⁺, 180 (100) [FSA]⁻; Anal. Calcd. for C₁₂H₂₈N₂F₂O₄S₂: C, 39.3; H, 7.7; N, 7.6; F, 10.4; Found: C, 39.2; H, 7.5; N, 7.8; F, 10.4.

### PMI[FSA]

MS m/z (%) 125 (100) [PMI], 180 (100) [FSA]⁻; Anal. Calcd. for C₇H₁₃N₃F₂O₄S₂: C, 27.5; H, 4.3; N, 13.8; F, 12.4; Found: C, 27.7; H, 4.2; N, 13.7; F, 12.5.

### PMI [TFSA]

MS m/z (%) 125 (100) [PMI], 280 (100) [TFSA]; Anal. Calcd. for C₉H₁₃N₃F₆O₄S₂: C, 26.7; H, 3.3; N, 10.4; F, 28.1; Found: C, 26.7; H, 3.2; N, 10.5; F, 27.9.

### N1224[TFSA]

MS m/z (%) 144 (100) [N1224]⁺, 280 (100) [TFSA]⁻; Anal. Calcd. for C₁₁H₂₂N₂F₆O₄S₂: C, 31.1; H, 5.2; N, 6.6; F, 26.9; Found: C, 31.0; H, 5.0; N, 6.6; F, 26.9.

### DMI[TFSA]

MS m/z (%) 97 (100) [DMI]⁺, 280 (100) [TFSA]⁻; Anal. Calcd. for C₇H₉N₃F₆O₄S₂: C, 22.3; H, 2.4; N, 11.1; F, 30.2; Found: C, 22.1; H, 2.5; N, 11.4; F, 30.0.

### DMI[FSA]

MS m/z (%) 97 (100) [DMI]⁺, 180 (100) [FSA]⁻; Anal. Calcd. for C₅H₉N₃F₂O₄S₂: C, 21.7; H, 3.3; N, 15.2; F, 13.7; Found: C, 21.7; H, 3.3; N, 15.2; F, 13.7.

### N1224[FSA]

MS m/z (%) 144 (100) [N1224]⁺, 280 (100) [TFSA]⁻; Anal. Calcd. for C₉H₂₂N₂F₂O₄S₂: C, 33.3; H, 6.8; N, 8.6; F, 11.7; Found: C, 33.3; H, 6.6; N, 8.8; F, 11.9.

### N1133[FSA]

MS m/z (%) 130 (100) [N1133]⁺, 180 (100) [FSA]⁻; Anal. Calcd. for C₈H₂₀N₂F₂O₄S₂: C, 31.0; H, 6.5; N, 9.0; F, 12.2; Found: C, 30.7; H, 6.2; N, 9.0; F, 12.2.

### N1133[TFSA]

MS m/z (%) 130 (100) [N1133]⁺, 280 (100) [FSA]⁻; Anal. Calcd. for C₁₀H₂₀N₂F₆O₄S₂: C, 29.3; H, 4.9; N, 6.8; F, 27.8; Found: C, 29.1; H, 4.6; N, 6.8; F, 27.6.

### N1224[FTA]

MS m/z (%) 144 (100) [N1224]⁺, 230 (100) [FTA]⁻; Anal. Calcd. for C₁₀H₂₂N₂F₄O₄S₂: C, 32.1; H, 5.9; N, 7.5; F, 20.3; Found: C, 32.2; H, 5.7; N, 7.6; F, 20.3.

### N3333[FTA]

MS m/z (%) 186 (100) [N3333]⁺, 230 (100) [FTA]⁻; Anal. Calcd. for C₁₃H₂₈N₂F₄O₄S₂: C, 37.5; H, 6.8; N, 6.7; F, 18.3; Found: C, 37.4; H, 6.5; N, 6.8; F, 18.3.

### N4444[FTA]

MS m/z (%) 242 (100) [N4444]⁺, 230 (100) [FTA]⁻; Anal. Calcd. for C₁₇H₃₆N₂F₄O₄S₂: C, 43.2; H, 7.7; N, 5.9; F, 16.1; Found: C, 43.3; H, 7.5; N, 6.0; F, 15.9.

### N5555[FTA]

MS m/z (%) 296 (100) [N5555]⁻, 230 (100) [FTA]⁻; Anal. Calcd. for C₂₁H₄₄N₂F₄O₄S₂: C, 47.7; H, 8.4; N, 5.3; F, 14.4; Found: C, 47.3; H, 8.5; N, 5.3; F, 14.2.

### PP12[FSA]

MS m/z (%) 128 (100) [PP12]⁺, 180 (100) [FSA]; Anal. Calcd. for C₈H₁₆N₂F₂O₄S₂: C, 31.2; H, 5.9; N, 9.1; F, 12.3; Found: C, 30.9; H, 5.6; N, 9.1; F, 12.3.

### Py12[FTA]

MS m/z (%) 114 (100) [Py12]⁺, 230 (100) [FTA]⁻; Anal. Calcd. for C₈H₁₆N₂F₂O₄S₂: C, 27.9; H, 4.7; N, 8.1; F, 22.1; Found: C, 27.9; H, 4.7; N, 8.3; F, 21.9.

### Py14[FTA]

MS m/z (%) 142 (100) [Py14]⁺, 230 (100) [FTA]⁻; Anal. Calcd. for C₁₀H₂₀N₂F₄O₄S₂: C, 32.25; H, 5.41; N, 7.52; F, 20.41; Found: C, 32.11; H, 5.16; N, 7.61; F, 20.43.

### Py14[FSA]

MS m/z (%) 142 (100) [Py14]⁺, 180 (100) [FSA]⁻; Anal. Calcd. for C₉H₂₀N₂F₂O₄S₂: C, 33.53; H, 6.25; N, 8.69; F, 11.79; Found: C, 33.29; H, 6.00; N, 8.80; F, 11.78.

### BMI [FTA]

MS m/z (%) 139 (100) [BMI]⁺, 230 (100) [FTA]⁻; Anal. Calcd. for C₉H₁₅N₃F₄O₄S₂: C, 29.3; H, 4.1; N, 11.4; F, 20.6; Found: C, 29.1; H, 4.1; N, 11.4; F, 20.4.

### PMI[FTA]

MS m/z (%) 125 (100) [PMI]⁺, 230 (100) [FTA]⁻; Anal. Calcd. for C₉H₁₃N₃F₄O₄S₂: C, 27.0; H, 3.7; N, 11.8 F, 21.4; Found: C, 27.1; H, 3.6; N, 11.9; F, 21.3.

### DMI [FTA]

MS m/z (%) 97 (100) [DMI]⁺, 230 (100) [FTA]⁻; Anal. Calcd. for C₆H₉N₃F₄O₄S₂: C, 22.0; H, 2.8; N, 12.8 F, 22.3; Found: C, 22.1; H, 2.8; N, 13.1; F, 23.3.

### BMI [FTA]

MS m/z (%) 139 (100) [BMI]⁺, 230 (100) [FTA]; Anal. Calcd. for C₉H₁₅N₃F₄O₄S₂: C, 29.3; H, 4.1; N, 11.4; F, 20.6; Found: C, 29.1; H, 4.1; N, 11.4; F, 20.4.

### Py12[FSA]

MS m/z (%) 114 (100) [Py12]⁺, 180 (100) [FSA]⁻; Anal. Calcd. for C₇H₁₆N2F₂O₄S₂: C, 28.6; H, 5.5; N, 9.5; F, 12.9; Found: C, 28.4; H, 5.3; N, 9.6; F, 12.9.

### AS44[FTA]

MS m/z (%) 126 (100) [AS44]⁺, 230 (100) [FTA]⁻; Anal. Calcd. for C₉H₁₆N₂F₄O₄S₂: C, 30.3; H, 4.5; N, 7.9; F, 21.3; Found: C, 30.1; H, 4.5; N, 7.7; F, 21.2.

### AS44[TFSA]

MS m/z (%) 126 (100) [AS44]⁺, 280 (100) [TFSA]⁻; Anal. Calcd. for C₁₀H₁₆N₂F₆O₄S₂: C, 29.6; H, 4.0; N, 6.9; F, 28.1; Found: C, 29.1; H, 3.9; N, 6.8; F, 28.1.

### AS44[FSA]

MS m/z (%) 126 (100) [AS44]⁺, 180 (100) [FSA]⁻; Anal. Calcd. for C₈H₁₆N₂F₂O₄S₂: C, 31.4; H, 5.3; N, 9.1; F, 12.4; Found: C, 31.0; H, 9.2; N, 12.4; F, 31.1.

### PS44[FTA]

MS m/z (%) 143 (100) [PS44]⁺, 230 (100) [FTA]⁻; Anal. Calcd. for C₉H₁₆NPF₄O₄S₂: C, 29.0; H, 4.3; N, 3.8; F, 20.0; Found: C, 39.2; H, 4.1; N, 3.9; F, 19.6.

### PS44[FSA]

MS m/z (%) 143 (100) [PS44]⁺, 180 (100) [FSA]⁻; Anal. Calcd. for C₈H₁₆NPF₂O₄S₂: C, 29.7; H, 5.0; N, 4.4; F, 11.8; Found: C, 29.7; H, 4.8; N, 4.3; F, 11.5.

### PS44 [TFSA]

MS m/z (%) 143 (100) [PS44]⁺, 280 (100) [TFSA]⁻; Anal. Calcd. for C₁₀H₁₆NPF₆O₄S₂: C, 28.4; H, 3.8; N, 3.3; F, 26.5; Found: C, 28.5; H, 3.7; N, 3.4; F, 26.9.

### Test Example 1

Tables 1 to 6 show the melting points, electrical conductivities, glass transition points, thermal decomposition temperatures, viscosities, and densities of the compounds obtained in the Examples and Comparative Examples above.

TABLE 1
Melting Point/° C.

| | FTA | FSA | TFSA |
|---|---|---|---|
| N1111 | 117 | >300 | 133 |
| N1112 | 63 | 263 | 110 |
| N1113 | −28 | 42 | 19 |
| N1122 | −13 | 200 | 98 |
| N1133 | Tg only | 6 | 39 |
| N2221 | 3.6 | 130 | 97 |
| N1224 | Tg only | −16 | 9.4 |
| DEME | Tg only | −22 | Tg only |
| N2222 | 8.5 | 40 | 96 |
| N3333 | 105 | 142 | 106 |
| N4444 | 60 | 99 | 89 |
| N5555 | 18 | 96 | 28 |
| AS44 | 21 | 195 | 114 |
| PS44 | −18.5 | 67.2 | 95.9 |
| DMI | 9.9 | 57 | 23 |
| PMI | Tg only | Tg only | Tg only |
| BMI | −16.5 | Tg only | −2 |
| P2222 | 44 | 73 | 115 |
| Py11 | 118 | 230 | 134 |
| Py12 | −12 | 203 | 88 |
| Py14 | Tg only | −16 | −18 |
| PP11 | 95 | 277 | 124 |
| PP12 | −8.1 | 152 | 86 |
| PP13 | Tg only | 3 | 12 |
| PP14 | Tg only | Tg only | Tg only |

TABLE 2
Conductivity (25° C.) mS/cm

| | FTA | FSA | TFSA |
|---|---|---|---|
| N1111 | solid | solid | solid |
| N1112 | solid | solid | solid |
| N1113 | 5.4 | solid | 2.9 |
| N1122 | solid | solid | solid |
| N1133 | 3.7 | 5.6 | solid |
| N2221 | 4.3 | solid | solid |
| N1224 | 2.8 | 4.5 | 1.6 |
| DEME | 4.1 | 5.6 | 2.6 |
| N2222 | 3.3 | solid | solid |
| N3333 | solid | solid | solid |
| N4444 | solid | solid | solid |
| N5555 | 0.16 | solid | 0.15 |
| AS44 | 7.0 | solid | solid |
| PS44 | 5.0 | solid | solid |
| DMI | 12.1 | solid | 9.0 |
| PMI | 8.0 | 10.6 | 5.5 |
| BMI | 6.0 | 7.8 | 4.2 |
| P2222 | solid | solid | solid |
| Py11 | solid | solid | solid |
| Py12 | 3.4 | solid | solid |
| Py14 | 4.6 | 6.2 | 2.6 |
| PP11 | solid | solid | solid |
| PP12 | 3.4 | solid | solid |
| PP13 | 2.6 | 3.7 | 1.5 |
| PP14 | 2.1 | 2.7 | 1.1 |

TABLE 3
Glass Transition Temperature/° C.

| | FTA | FSA | TFSA |
|---|---|---|---|
| N1111 | — | — | — |
| N1112 | — | — | — |
| N1113 | −103 | — | — |
| N1122 | — | — | — |
| N1133 | −101 | — | — |
| N2221 | — | — | — |
| N1224 | −110 | −113 | −92 |
| DEME | −107 | −112 | −94.6 |
| N2222 | — | — | — |
| N3333 | — | — | — |
| N4444 | — | — | — |
| N5555 | — | — | −69 |
| AS44 | — | — | — |
| PS44 | −93 | — | — |
| DMI | — | — | — |
| PMI | −104 | −103 | −90 |
| BMI | −101 | −100 | −89 |
| P2222 | — | — | — |
| Py11 | — | — | — |
| Py12 | — | — | — |
| Py14 | −106 | — | −88 |
| PP11 | — | — | — |
| PP12 | — | — | — |
| PP13 | −94 | — | — |
| PP14 | −92 | −94 | −78 |

TABLE 4
Viscosity (25° C.) cP

| | FTA | FSA | TFSA |
|---|---|---|---|
| N1111 | solid | solid | solid |
| N1112 | solid | solid | solid |
| N1113 | 47 | solid | 82 |
| N1122 | solid | solid | solid |
| N1133 | 64 | 58 | solid |
| N2221 | 57 | solid | solid |
| N1224 | 81 | 80 | 129 |
| DEME | 53 | 46 | 70 |
| N2222 | 80 | solid | solid |
| N3333 | solid | solid | solid |
| N4444 | solid | solid | solid |
| N5555 | 632 | solid | 554 |
| AS44 | 44.0 | solid | solid |
| PS44 | 57.1 | solid | solid |
| DMI | 26 | solid | 39 |
| PMI | 34 | 30 | 46 |
| BMI | 38 | 34 | 52 |
| P2222 | solid | solid | solid |
| Py11 | solid | solid | solid |
| Py12 | 77 | solid | solid |
| Py14 | 55 | 56 | 76 |
| PP11 | solid | solid | solid |
| PP12 | 77 | solid | solid |
| PP13 | 96 | 95 | 150 |
| PP14 | 117 | 123 | 182 |

TABLE 5
Thermal Decomposition Temperature/° C.

| | FTA | FSA | TFSA |
|---|---|---|---|
| N1111 | 291 | 289 | 420 |
| N1112 | 317 | 331 | 410 |
| N1113 | 326 | 310 | 405 |
| N1122 | 297 | 323 | 407 |
| N1133 | 259 | 292 | 403 |
| N2221 | 314 | 297 | 394 |
| N1224 | 274 | 298 | 398 |
| DEME | 299 | 293 | 380 |
| N2222 | 305 | 312 | 400 |
| N3333 | 252 | 289 | 376 |
| N4444 | 350 | 292 | 375 |
| N5555 | 354 | 297 | 371 |
| AS44 | 304 | 308 | 437 |
| PS44 | 306 | 333 | 423 |
| DMI | 306 | 308 | 428 |
| PMI | 329 | 323 | 416 |
| BMI | 311 | 272 | 424 |
| P2222 | 350 | 316 | 415 |
| Py11 | 291 | 293 | 414 |
| Py12 | 361 | 294 | 417 |
| Py14 | 370 | 299 | 423 |
| PP11 | 275 | 294 | 421 |
| PP12 | 321 | 313 | 418 |
| PP13 | 366 | 291 | 424 |
| PP14 | 365 | 291 | 420 |

TABLE 6
Density (25° C.)/g/mL

| | FTA | FSA | TFSA |
|---|---|---|---|
| N1111 | solid | solid | solid |
| N1112 | solid | solid | solid |
| N1113 | 1.41 | solid | 1.43 |
| N1122 | solid | solid | solid |
| N1133 | 1.34 | 1.28 | solid |
| N2221 | 1.37 | solid | solid |
| N1224 | 1.31 | 1.24 | 1.36 |
| DEME | 1.37 | 1.27 | 1.42 |
| N2222 | 1.38 | solid | solid |
| N3333 | solid | solid | solid |
| N4444 | solid | solid | solid |
| N5555 | 1.14 | solid | 1.16 |
| AS44 | 1.46 | solid | solid |
| PS44 | 1.48 | solid | solid |
| DMI | 1.51 | solid | 1.56 |
| PMI | 1.38 | 1.40 | 1.49 |
| BMI | 1.43 | 1.33 | 1.46 |
| P2222 | solid | solid | solid |
| Py11 | solid | solid | solid |
| Py12 | 1.42 | solid | solid |
| Py14 | 1.38 | 1.32 | 1.41 |
| PP11 | solid | solid | solid |
| PP12 | 1.42 | solid | solid |
| PP13 | 1.39 | 1.34 | 1.41 |
| PP14 | 1.39 | 1.30 | 1.39 |

### Test Example 2

Reduction limit potential, oxidation limit potential, and potential window were measured for the various ionic liquids of the Examples and Comparative Examples. The results are shown in Table 7 and FIG. 1. The values indicated by “*” in Table 7 were cited from the cited document*:
Cited document*: Hajime MATSUMOTO et al., Journal of Power Sources, Vol. 160, Issue 2 (2006), pp. 1308-1313

### Measurement Results of Potential Windows

### 25° C.

Scan speed: 50 mV/s
Working electrode: glassy carbon electrode
Counter electrode: platinum
Reference electrode:
The reference electrode was a platinum wire immersed in an iodine redox containing 60 mM tetrapropylammonium iodide and 15 mM iodine in EMI [TFSI], which was placed in a glass tube sealed with porous vycor glass at its end (the redox potential of ferrocene in each ionic liquid was measured as an internal standard).

Measurement results of potential windows for N2222[FTA], N122.102[FTA], EMI [FTA], and AS44[FTA] are shown in FIG. 1.

Note that N122.102[FTA] denotes DEME[FTA].

The reduction limit potential and oxidation limit potential shown in Table 7 were measured at 1 mA/cm².

TABLE 7

| | Reduction | Oxidation | | |
|---|---|---|---|---|
| | Limit | Limit | | |
| | Potential/V | Potential/V | Potential | |
| | vs Fc/Fc+ | vs Fc/Fc+ | Window/V | |
| PP13[TFSA] | −3.4 | 2.5 | 5.9 | * |
| PP13[FSA] | −3.2 | 2.4 | 5.6 | * |
| N2222[FTA] | −3.2 | 2.6 | 5.8 | |
| N122.1O2[TFSA] | −3.3 | 2.3 | 5.6 | |
| N122.1O2[FTA] | −3.2 | 2.3 | 5.5 | |
| EMI[TFSA] | −2.5 | 2.1 | 4.6 | * |
| EMI[FSA] | −2.5 | 2.0 | 4.5 | * |
| EMI[FTA] | −2.5 | 2.0 | 4.5 | |

These results revealed that the FTA anion exhibits a high electrochemical stability comparable to that of the known TFSA and FSA.

In particular, the FTA anion allows the use of N2222 as a cation, and has the most positive oxidation limit potential of the existing amide anions.

### Test Example 3

Li/LiCoO₂ cells were prepared according to the same method as described in Reference Document 8, using ethylene carbonate/dimethyl carbonate (EC/DMC) solutions each containing EMI [FTA], AS44[FTA], or 1M Li—PF₆. After a rate test, each cell was charged at 4.2 V, and the AC impedance was measured.

Moreover, the relationship between discharge capacity and C rate was measured for each of the Li/LiCoO₂ cells prepared using AS44[FTA], EMI [FTA], EMI [FSA], EMI [TFSA], Py13[TFSA], and Py13[FSA]. The measurement results for each cell are shown in FIGS. 2 and 3. Lithium electrolytes were prepared by dissolving a lithium salt, Li-TFSA (0.5 M), in the ionic liquids. The cells were constructed based on Reference Document 9.

From the results shown in FIG. 2, it is observed that the interfacial resistance for EMI-FTA is not very high, even in comparison with that of EC+DMC, and, thus, is relatively low. Further, from the results shown in FIG. 3, it is observed that the cell using EMI [FTA] exhibits performance substantially equivalent to that of the cell using EMI [FSA], and that the cell using AS44[FTA] exhibits performance substantially equivalent to that of the cell using Py13[FSA] with a lower viscosity. This confirmed that TFSA enables charging/discharging at 1 C (0.2 mA/cm²) or more, which has not been made possible by using any low-viscosity systems. According to the AC impedance measurement, the FTA-based ionic liquids exhibit low values of apparent interfacial charge transfer resistance, which are close to those of the FSA-based ionic liquids. This indicates that the presence of —FSO₂ groups in the anions causes the interfacial resistance to decrease, which is believed to be a cause of the high rate characteristics.

The effects of separator thickness and Li-salt concentration upon the charge/discharge rate characteristics (25° C.) of the Li/LiCoO₂ cell using AS₄₄ [FTA] were investigated, and cell optimization was performed. As a result, it was observed, as shown in FIG. 4, that the cell using AS₄₄ [FTA] exhibited charge/discharge rate characteristics as high as those of known organic solvent electrolytes. This high performance can be attributed to the following reasons: increasing the lithium salt concentration reduced the interfacial charge transfer resistance at the positive and negative electrodes; and, as shown in FIG. 5, while the addition of approximately 1 M lithium salt increased the viscosity of the known TFSA ionic liquid significantly, i.e., seven-fold or more, the viscosities of the FTA ionic liquids did not significantly change, as with the FSA ionic liquid.
Reference Document 1: S. Kongpricha, W. C. Preusse, R. Schwarer, J. K. Ruff, Inorganic Syntheses, 8, 151-155.
Reference Document 2: Z. B. Zhou, M. Takeda, M. Ue, J Fluorine Chem., 123 (2003), 127-131.
Reference Document 3: Z. B. Zhou, H. Matsumoto, K. Tatsumi, Chem. Eur. J., 10 (2004), 6581-6591.
Reference Document 4: Zhi-bin Zhou, Hajime Matsumoto, Kuniaki Tatsumi, Chem. Eur. J., 11 (2005), 752-766.
Reference Document 5: Zhi-bin Zhou, Hajime Matsumoto, Kuniaki Tatsumi, Chem. Eur. J., 12 (2006), 2196-2212.
Reference Document 6: V. Braun, Chemische Berichte, 49 (1916), 970.
Reference Document 7: N. Ya Derkach, A. V. Kirsanov, Zhurnal Obshchei Khimii, 38 (2) (1968), 331-7.
Reference Document 8: H. Sakaebe et al., Electrochim. Acta, 53 (2007), 1048.
Reference Document 9: H. Sakaebe, H. Matsumoto, Electrochem. Commun., 5 (7) (2003), 594.

### BRIEF DESCRIPTION OF DRAWINGS

FIG. 1 shows a linear sweep voltammogram at 25° C. of N2222[FTA], DEME[FTA], EMI [FTA], and AS44[FTA].

FIG. 2 shows the measurement results of AC impedances (a Cole-Cole plot) of Li/LiCoO₂ cells, each using an electrolyte obtained by adding approximately 0.5 M Li[TFSA] to EMI [FTA] or AS44[FTA], or using an EC/DMC (1:1) solution containing 1 M L₁-PF₆; the AC impedances were determined after subjecting the cells to a rate test, followed by charging at 4.2 V.

FIG. 3 shows the relationship between charge/discharge capacity and C rate measured for Li/LiCoO₂ cells prepared using EMI [FTA], AS44[FTA], EMI [FSA], and EMI [TFSA].

FIG. 4 shows the effects of the Li-salt concentration and separator thickness upon the rate characteristics of a Li/LiCoO₂ cell using AS44[FTA] as an electrolyte.

FIG. 5 shows the coexisting Li-salt concentration dependencies upon the viscosities of ionic liquids.

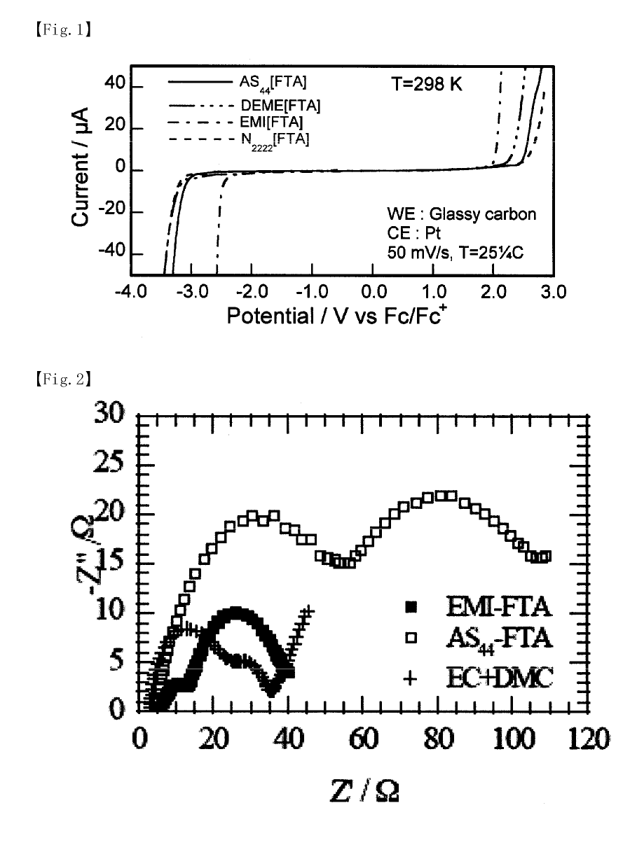

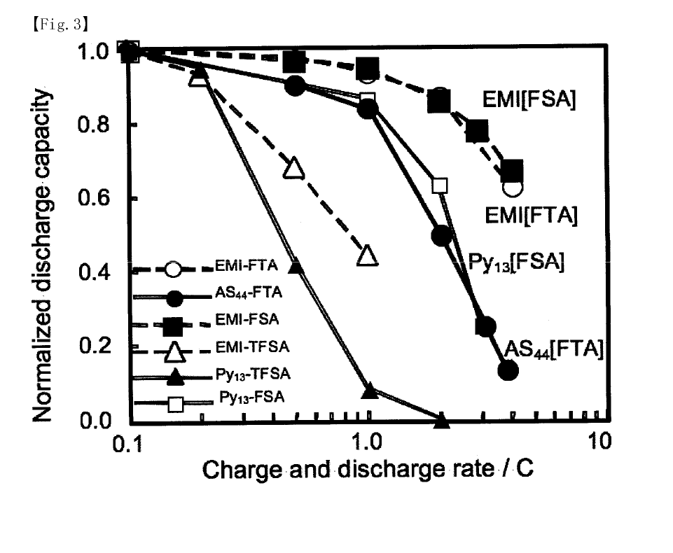

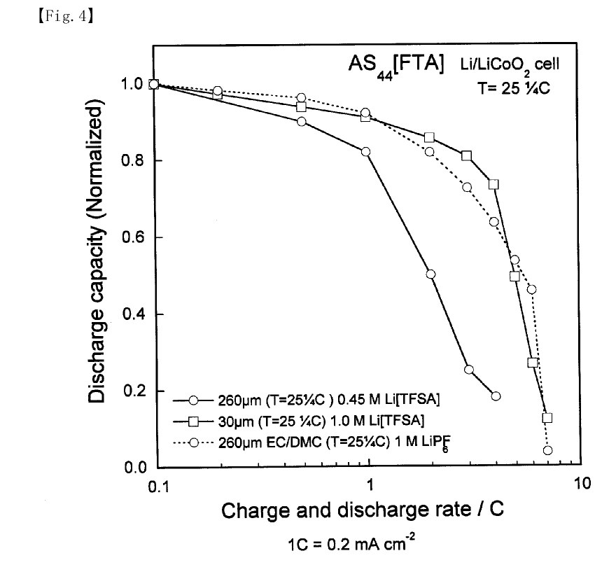

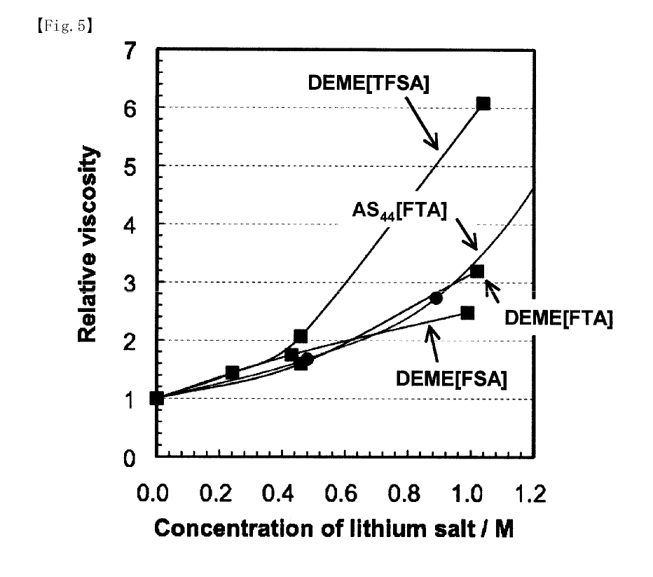

1. An ionic liquid comprising fluorosulfonyl(trifluoromethylsulfonylamide) (FTA) as an anion and a cation selected from the following cations:
tetramethylammonium (N1111);
ethyltrimethylammonium (N1112);
n-propyltrimethylammonium (N1113);
diethyldimethylammonium (N1122);
di-n-propyldimethylammonium (N1133);
triethylmethylammonium (N2221);
n-butyldiethylmethylammonium (N1224);
N,N-diethyl-N-methyl-N-(2-methoxyethyl)ammonium (DEME);
tetraethylammonium (N2222);
tetra-n-propylammonium (N3333);
tetra-n-butylammonium (N4444);
tetra-n-pentylammonium (N5555);
5-azoniaspiro[4.4]nonane (AS44);
dimethylimidazole (DMI);
propylmethylimidazole (PMI);
butylmethylimidazole (BMI);
N,N-dimethylpyrrolidinium (Py11);
N-methyl-N-ethylpyrrolidinium (Py12);
N-methyl-N-butylpyrrolidinium (Py14);
N,N-dimethyl-piperidinium (PP11);
N-methyl-N-ethyl-piperidinium (PP12);
N-methyl-N-propyl-piperidinium (PP13);
N-methyl-N-butyl-piperidinium (PP14);
tetraethylphosphonium (P2222); and
5-phosphoniaspiro[4,4]nonane (PS44).

2. The ionic liquid according to claim 1, wherein the cation is tetraethylammonium (N2222) or triethylmethylammonium (N2221).

3. The ionic liquid according to claim 1, wherein the cation is tetramethylammonium (N1111), ethyltrimethylammonium (N1112), or n-propyltrimethylammonium (N1113).

4. The ionic liquid according to claim 1, wherein the cation is N,N-diethyl-N-methyl-N-(2-methoxyethyl)ammonium (DEME).

5. The ionic liquid according to claim 1, wherein the cation is tetraethylphosphonium (P2222).

6. The ionic liquid according to claim 1, wherein the cation is N-methyl-N-propyl-piperidinium (PP13).

7. The ionic liquid according to claim 1, wherein the cation is 5-azoniaspiro[4.4]nonane (AS44).
